(19) United States
(12) Patent Application Publication
(10) Pub. No.: US 2006/0267795 A1
(43) Pub. Date: Nov. 30, 2006

(54) Traffic information system for conveying information to drivers

(75) Inventors: Maurice Herman Johan Draaijer, Eindhoven (NL); Paulus Henrikus Johan Damink, Eindhoven (NL); Maurice Leonardus Anna Stassen, Eindhoven (NL); Sel Brian Colak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/555,396

(22) PCT Filed: May 5, 2004
(86) PCT No.: PCT/IB04/50587

§ 371 Date: Nov. 2, 2005

(30) Foreign Application Priority Data
May 7, 2003 (EP) 03101260.2

(51) Int. Cl. G08G 1/095

(52) U.S. Cl. 340/907

(57) ABSTRACT

A versatile traffic information system (1) comprises: a light source (10), designed for generating a relative narrow, intense light beam (11); housing means (100) adapted for being mounted adjacent or above a road surface (3), accommodating the light source (10), having a beam exit window (101) for allowing the light beam (11) to exit the housing; a controllable beam deflection system (20), capable of changing a direction of the light beam (11) towards a projection area (2) on the road surface (3) in order to form a relatively small light spot (12) on the projection area (2);- a control circuit (30) for controlling the controllable beam deflection system (20) such as to effectively make the light spot (12) draw a predefined pattern (4) on the projection area (2).

The present invention relates in general to the field of traffic information systems, i.e. systems capable of conveying information to traffic participants, specifically car drivers.

There is a general desire to be able to convey information to car drivers. The information to be conveyed can be of a various nature. For instance, it may be desirable to inform a car driver of news facts, weather conditions, traffic jams, etc. For this type of information, it is common to use radio broadcast (AM/FM) by central broadcasting stations. However, this type of information is of a general nature, intended to be received by a large number of persons within a large area Broadcasting information by central broadcasting stations is not a suitable system if it is desired to convey information only locally, to a very limited number of persons.

Further, a disadvantage of a broadcasting system is that the “addressees” need to have specific equipment in order to be able to receive the information. This disadvantage is especially a serious disadvantage in case the information to be conveyed relates to traffic safety issues. For instance, in case a road is blocked by an accident, or is slippery because of icy weather conditions, road management wants to be able to assure that the message arrives at all car drivers approaching the spot in question, while it is not necessary to broadcast such message nation-wide. Thus, there is a need for a local traffic information system.

For locally informing approaching car drivers, basically three different types of systems have been developed, and implemented to a larger or lesser degree. As a first system, traffic signs should be mentioned, i.e. signs which inform or warn a driver on a traffic situation ahead (e.g. approaching dangerous crossing), or which instruct him to take an action (e.g. give way, take a right turn) or, in contrast, forbid him to take a certain action (no left turns allowed; speed limitation). Such signs, typically applied on shields mounted on posts, or applied on the road surface, are stationary signs, intended for continuous use in continuous circumstances. A problem of these signs is that they suffer from reduced visibility in bad weather conditions such as snow.

For variable use, traffic lights may be mentioned, i.e. the well-known red-orange-green lights, used for controlling traffic at, for instance, intersecting roads. Generally speaking, such system comprises a plurality of lights of mutually different colour, which have a certain predefined meaning, understood by everyone, when lit. However, each lamp can only be ON or OFF, and such system can convey only a limited number of predefined messages (red=STOP, green=GO ON, ORANGE=PREPARE TO STOP/GO).

As a second system, capable of conveying almost any kind of message, controllable text panels may be mentioned. Usually, such controllable text panels are implemented as matrix panels, each pixel being implemented by an individual lamp. By suitable control, characters can be formed which can be read by approaching car drivers.

A major disadvantage of these text panels, either placed next to the road or suspended over the road, is the fact that the car driver, in order to be able to read the message, must take his eyes off of the road for a relatively long time. Thus, these systems basically take the driver's attention away from where the attention should be, namely on the road.

In many instances, information to be conveyed is actually only guidance information, intended to guide a car driver. From the very nature of this purpose, traffic guiding systems should not take the attention of the driver away from the road. Therefore, quite naturally, traffic signs are used for this purpose, in the form of markings applied to the surface of the road. Such guiding markings typically include stripings and arrows, but also priority triangles and speed limitations are marked on the road surface. These commonly used markings have several disadvantages: they are stationary (i.e. they can not be switched on/off or be varied), they suffer from wear and tear caused by traffic, they are hardly visible during rain or snow, and they are slippery, which is specifically dangerous to (motor) bike drivers.

As a third system, a light projection system may be mentioned, such as for example disclosed in EP-0.677.160. In such projection system, a light source generates a beam of light which is directed from above to the road surface in order to project a certain pattern. The pattern can be a guiding line, a direction arrow, ciphers, etc.

An advantage of such projection system is that the “information” is provided on the surface of the road, so a driver does not need to divert his eyes. However, the system as described in EP-0.677.160 has several disadvantages. An important disadvantage is that the known system is only suitable for projecting one predefined pattern; the only variation possibility in this system is the fact that the light source can be switched ON or OFF. Further, the pattern projected on the road surface has a relatively low intensity, caused by the fact that the pattern is generated by passing a broad beam through a mask, so that the pattern is barely or not visible during daylight conditions.

It is a general objective of the present invention to solve all or at least some of the above-mentioned problems.

According to an important aspect of the present invention, a traffic information system comprises a laser device, creating a powerful laser beam that is projected onto the road surface. A system of controllable beam deflectors makes the projection light spot scan a projection area of the road surface, such that the scanning light spot forms the pattern to be projected. A control circuit controls the beam deflectors. By amending the control operation, different patterns can be scanned. The control circuit can receive command instructions via a communication network. Thus, a very versatile system is provided, which can project virtually any kind of pattern, the pattern being quite bright.

These and other aspects, features and advantages of the present invention will be further explained by the following description with reference to the drawings, in which same reference numerals indicate same or similar parts, and in which:

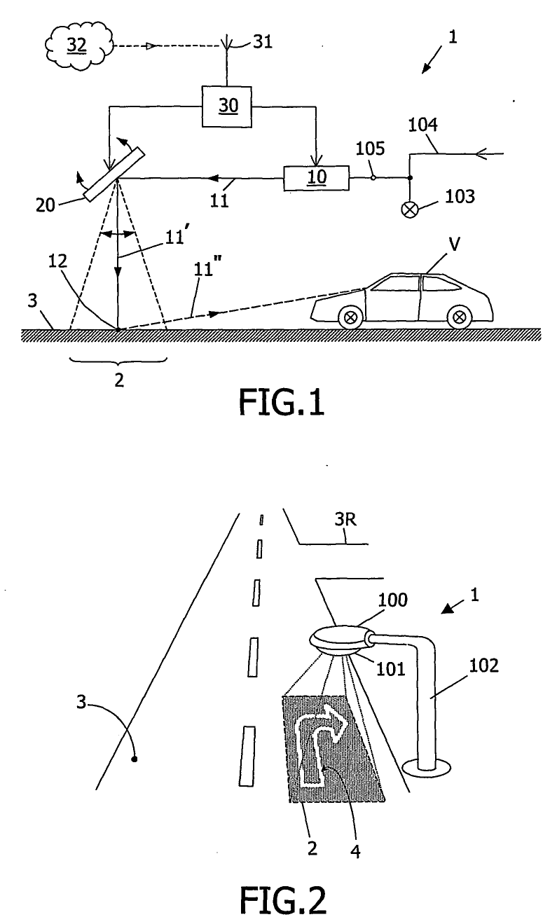

FIG. 1 is a diagram schematically illustrating a traffic information system according to the present invention;

FIG. 2 is a schematic perspective view of a road situation illustrating a possible use of the traffic information system according to the present invention;

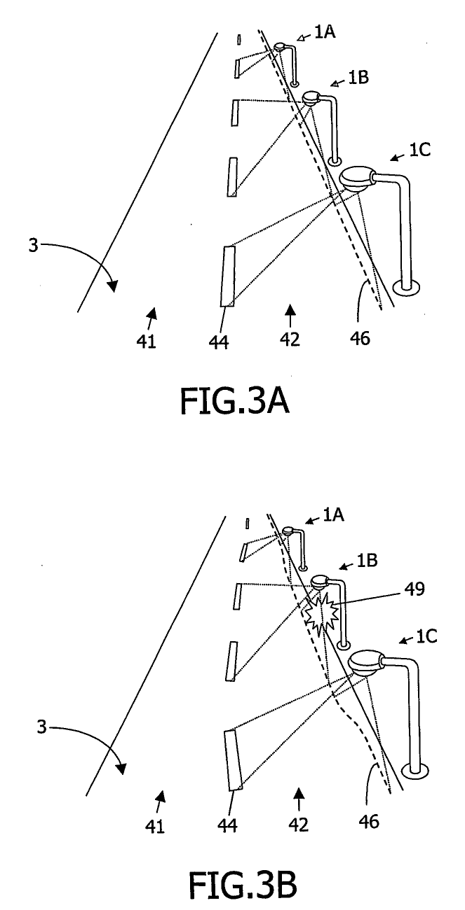

FIGS. 3A-B are schematic perspective views of a road situation illustrating another possible use of the traffic information system according to the present invention;

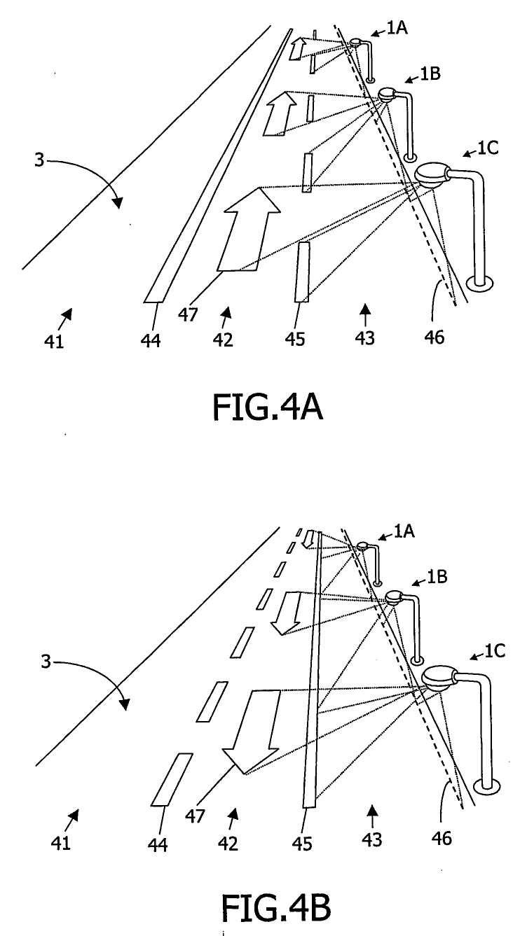

FIGS. 4A-B are schematic perspective views of a road situation illustrating another possible use of the traffic information system according to the present invention;

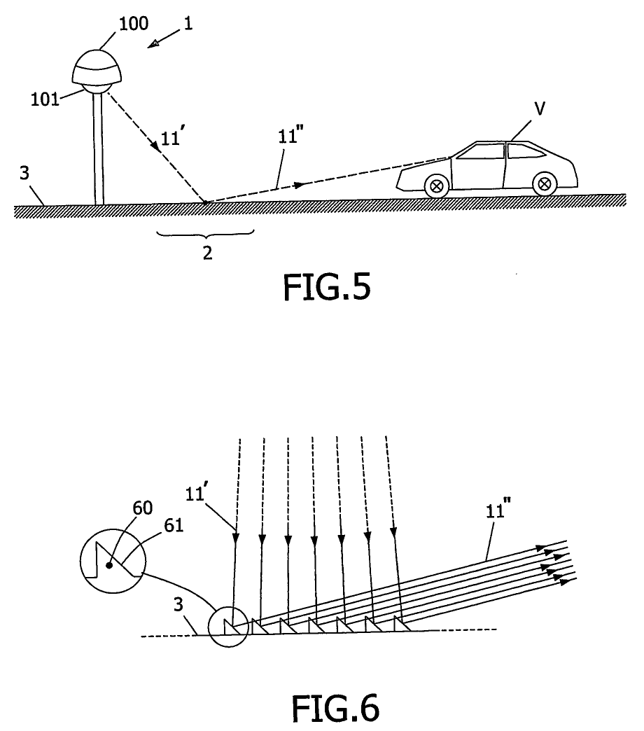

FIG. 5 is a side view illustrating a specific aspect of a particular embodiment of the traffic information system according to the present invention;

FIG. 6 is a schematic section of a portion of a road surface illustrating a specific aspect of a particular embodiment of the traffic information system according to the present invention.

FIG. 1 is a diagram schematically illustrating a traffic information system 1 according to the present invention. The traffic information system 1 comprises a light source 10, designed for generating a relative narrow, intense light beam 1; in a suitable and preferred embodiment, the light source 10 is implemented as a laser device. The light source 10 is accommodated in a housing 100, mounted above a road surface 3, and having a beam exit window 101 allowing the light beam 11 to exit the housing 100. In an advantageous embodiment, as illustrated in FIG. 2, the housing 100 is part of a street lighting armature, in this case fixed at the end of a lighting pole 102. Alternatively, the housing may be suspended above the road surface 3, such as known per se for street lighting, but this is not illustrated.

It is noted that the light source 10 may be arranged at a lower level, such as in the foot of the pole 102, in which case the light beam 11 is guided to the housing 100 via a light guide (not shown) arranged inside the pole 102. Such embodiment is, however, not preferred. For reasons of compact building and less complicated installation, it is preferred that the light source 10 and all further components of the system 1 are arranged inside the housing 100, preferably as a unit, unless specifically mentioned otherwise.

It is further noted that, technically, it is possible that the housing 100 is a dedicated housing, intended to only accommodate the traffic information system 1 according to the present invention. However, in a preferred embodiment, the housing 100 also functions as housing for street lighting. In such case, the housing 100 would thus accommodate the light source 10 of the traffic information system 1 according to the present invention and would also accommodate one or more common street lighting lamps 103, such as schematically illustrated in FIG. 1. Such embodiment has important advantages. First, in the case of a housing used for street lighting, electrical power is already available in the housing, such as indicated by electrical power line 104 in FIG. 1. Second, installing a traffic information system 1 according to the present invention can be quickly and easily done by mounting the system in an existing housing of an existing street lighting system and connecting the power input terminal 105 of the system to the existing electrical power line 104, without the need to make large infrastructural amendments.

The system further comprises a controllable beam deflection system 20, capable of changing the direction of the light beam 11 towards a projection area 2 of the road surface 3; the deflected beam is indicated at 11′. The deflection system 20 may comprise refractive elements, but preferably comprises only reflective elements in order to keep losses of light to a minimum. In FIG. 1, the deflection system 20 is symbolised by a single flat mirror; actually, the deflection system 20 may comprise multiple mirrors, some of which may have a fixed position, others may be arranged to swing around a swing axis or have variable orientations by other means. The deflection system 20 may also comprise a multi-facetted, rotating wheel or the like. All such elements are known per se in optical systems for obtaining optical effects with light beams, for instance in disco entertainment systems, and a detailed explanation of the design and operation of such elements is omitted here.

The light beam 11′, when hitting the road surface 3, forms a relatively small light spot 12, which can be seen (reflected light beam 11″) by the driver of an approaching vehicle V. Optics of the system 1 may be arranged such that the light spot 12 is a substantially round spot having a suitable diameter in the range of 1 mm to 100 mm, a diameter in the order of about 10 mm appearing most suitable.

Said light spot 12 is stationary when the deflection system 20 is kept stationary. As will be clear to a person skilled in the art, the light spot 12 is displaced over the projection area 2 of the road surface 3 when any one of the deflecting elements of the deflection system 20 is moved. Typically, the displacement of the light spot 12 may be a linear displacement. The controllable beam deflection system 20 is controlled by a control circuit 30 in such a way that the light spot 12 follows a predetermined path. After having completed the predetermined path, control repeats itself, so that the said predetermined path is repeatedly travelled by the light spot 12, at such a speed that the human eye can not perceive a travelling light spot but can only perceive an illuminated pattern 4 with the shape of said path. So, effectively, the travelling light spot writes or draws a predefined pattern 4 on the projection area 2.

As compared to a dia-projection type of illumination, the illumination of the present invention is very effective (light power per unit area per unit time).

In FIG. 2, an example is illustrated where the pattern 4 is the contour of an arrow, comprised of a plurality of line segments. As mentioned, the deflection system 20 can be controlled such that the light spot 12 follows the contour. In such case, the light source 10 would be continuously ON. In practice, however, it may be easier for the control of the deflection system 20 if the light spot is displaced to scan parallel lines in turn, such that the entire projection area 2 is scanned, even the parts which should not be illuminated. In such case, the light source 10 may be a controllable light source, also controlled by the control circuit 30. The control circuit 30 may switch off the light source 10 if the light spot 12 would fall on a part of the projection area 2 which should not be illuminated, and may switch on the light source 10 if the light spot 12 would fall on a part of the projection area 2 which should be illuminated because it forms part of the pattern. The scan speed of the light spot, i.e. the speed at which the light spot is displaced along a scanned line, may be constant along the line and may be constant for all lines. In that case, the pattern is rendered in a manner similar to the way a television image is “written”, as should be clear to a person skilled in the art.

Alternatively, or additionally, the light spot may be displaced to jump over dark portions of the pattern. It is preferred that the scan speed of the light spot is varied, such as to be increased when the light spot scans a dark part of the pattern or to be decreased when the light spot scans a bright part of the pattern. The light spot may even be displaced at such high speed that it effectively skips dark parts of the pattern. As a consequence, because no time is wasted by scanning dark parts, the light spot will effectively scan the bright parts more often, resulting in increased brightness of the bright parts of the pattern.

In FIG. 2, an example is illustrated where the pattern 4 is a sign, in this case an arrow pointing to the right, which is to indicate to an approaching car driver that he is to turn right at the next side street 3R. In this respect, the system 1 according to the present invention may operate as a general traffic guidance system, indicating in this example that the road ahead is temporarily blocked. However, the system 1 according to the present invention may also operate as an individual car guidance system, indicating one driver in this example that he should turn right in order to reach his destination. The next driver may see a different sign, for instance a straight arrow. As such, this system may be used as an alternative or addition to navigation systems aboard vehicles.

In another example (not illustrated), the pattern may be a number, e.g. “40”, indicating a temporary speed limit. This pattern will be the same for all drivers.

The position of the pattern 4 may be stationary, like signs painted on the road. In a preferred embodiment of the present invention, the control circuit 30 is designed to move the position of the pattern 4 along with the road traffic. For the approaching drivers, the effect will be that their relative speed with respect to the pattern 4 is reduced. The control circuit 30 may be designed to move the pattern 4 at a constant speed, independent of the speed of approaching cars. Preferably, however, the system is provided with a detection system for detecting position and/or speed of vehicles, and the control circuit 30 is designed, for a brief time, to move the pattern 4 with the same speed as an approaching vehicle, while positioning the pattern 4 just in front of this vehicle. This will greatly enhance the attention value of the projected pattern, and it will increase the chance that the pattern 4 is seen and understood by the driver, because the pattern is substantially stationary with respect to the vehicle.

Another, very interesting example is variable lane marking. Conventionally, lanes are marked by continuous or interrupted lines, painted along the lanes, on one side or both sides. Sometimes, it is desired to change the organisation of the road. For instance, in case of maintenance or construction work being done, or in case of an obstacle at a side of the road, it may be desired to temporarily reduce the width of the lanes, and/or to shift the position of the lanes. Or, in case of heavy traffic, it may be desirable to change from a road organisation having two relatively wide lanes (for one direction) to a road organisation having three relatively small lanes. In a conventional system, with painted lines, it is not possible to temporarily change the road organisation. Only in case of long-term work, the road organisation will be changed by painting different lines, sometimes in a colour (yellow) deviating from normal colour (white).

FIGS. 3A and 3B illustrate examples of the advantageous application of the present invention in this respect. FIG. 3A shows a portion of a road 3, with three traffic information systems 1A, 1B, 1C, in this case also indicated as traffic guidance systems. The road 3 has two lanes 41, 42, separated by a separation line 44, in this case an interrupted line. Along the side of the road, the second lane 42 is marked by a side marking line 46, also an interrupted line in this case. The situation depicted in FIG. 3A is quite common. The uncommon feature of this exemplary situation is that the separation line 44 and the side marking line 46 are provided as light patterns, projected by the traffic guidance systems 1A, 1B, 1C. It should be clear that the road 3 has more of such traffic guidance systems, but only three are shown for sake of simplicity.

Under normal circumstances, users will notice practically no difference with a situation where the lines are painted lines. An important advantage, however, results if the second lane 42 is partly blocked by an obstacle 49, which may be a broken down car, for instance. The traffic guidance systems 1A, 1B, 1C slightly change their projected light patterns, so that the side marking line 46 fluently bends inwards at some location before the obstacle, and bends back to the normal position beyond the obstacle. In between the bends, the side marking line 46 is shifted with respect to its original location. As a result, approaching traffic is smoothly guided past the obstacle. If the required shift of the side marking line 46 is such that the remaining width of the second lane 42 is insufficient for safe traffic, the separation line 44 may also bend away from the obstacle, so that the reduction of lane width is evenly distributed over the two lanes 41, 42.

If desired, the traffic guidance systems 1A, 1B, 1C may additionally project traffic signs for indicating a reduced maximum speed. After removal of the obstacle 49, the original situation can be quickly restored.

It should be recognized that a major advantage is achieved in that the temporary adaptation of the road guidance lines can be done quickly, without the need of workers being transported to the obstacle location, and without the need of temporarily closing the road for allowing the workers to arrange some kind of guiding barriers.

Another advantageous example of application of the present invention in this respect is illustrated in FIGS. 4A and 4B. Similarly as FIG. 3A, FIGS. 4A and 4B show a portion of a road 3, with three traffic guidance systems 1A, 1B, 1C. The road 3 has three lanes 41, 42, 43, separated by two separation lines 44, 45. The middle lane 42 is a variable direction line. In the situation of FIG. 4A, the middle lane 42 is open for traffic driving in the same direction as traffic in the third lane 43, as indicated by arrows 47 on the road surface of middle lane 42. The first separation line 44 between first lane 41 and middle lane 42 is a non-interrupted line, indicating that traffic on both sides of the line should not cross the line, while the second separation line 45 between third lane 43 and middle lane 42 is an interrupted line, indicating that traffic may cross this line.

It is noted that the present illustration is for right-hand traffic; necessary adaptations for left-hand traffic should be clear to a person skilled in the art. In contrast, in the situation of FIG. 4B, the middle lane 42 is open for traffic driving in the same direction as traffic in the first lane 41, as indicated by the arrows 47 now pointing in the opposite direction. The first separation line 44 between first lane 41 and middle lane 42 now is an interrupted line, while the second separation line 45 between third lane 43 and middle lane 42 now is a non-interrupted line.

This variable use is very advantageous in situations where the main direction of traffic is variable, for instance in the case of commuter's traffic, which will be in the direction from the homes to the offices in the morning and in the direction from the offices to the homes in the afternoon. Such variable use is not possible in case the lines are painted lines, but is now made easily possible by the invention if the lines 44, 45 and the arrows 47 are light patterns projected by the traffic guidance systems 1A, 1B, 1C, because all that is needed for changing the direction of middle lane 42 is for the traffic guidance systems 1A, 1B, 1C to change their projected light patterns, so that the first separation line 44 changes from a non-interrupted line to an interrupted line or vice versa, the second separation line 45 changes from an interrupted line to a non-interrupted line or vice versa, and the shape of the arrows 47 is inverted.

For safety reasons, it may be wise to have a transition period wherein traffic is not allowed on the middle lane at all, but this is not explained or illustrated further.

The controller 30 of the system 1 may be designed as a stand alone controller, adapted or programmed to continuously perform the same task. For instance, the pattern 4 may always be the same pattern. As an example, the pattern may be a sign warning the driver that he/she is approaching a dangerous situation, or the pattern may be indicating a speed limitation. On the other hand, the pattern 4 may be a changing pattern, but the changes follow a repetitive sequence. As an example, the controller 30 may be designed to always project one pattern during daylight and another pattern during darkness. As another example, the controller 30 may be designed to always project a specific pattern depending on time of day, which may be possible in the example discussed with reference to FIGS. 4A and 4B.

In a preferred embodiment, the operation of the controller 30 can be controlled from a distance. To this end, the controller 30 is provided with receiving means 31 adapted for receiving command signals. A supervisor (not shown) of the traffic information system 1, which supervisor may be a person or a central computer, is then able to send a command signal to the controller 30 who, in response, will perform a different control action such as to effect a different light pattern 4.

As an example, with reference to FIG. 2, if the road 3 ahead is blocked and the approaching traffic should turn right, this situation should be detected and the controller 30 should be given a corresponding command.

As another example, with reference to FIGS. 3A and 3B, if an obstacle 49 occurs, this situation should be detected, the location should be determined, the traffic guidance systems 1A, 1B, 1C in the proximity should be identified, and the corresponding controllers 30 should be given suitable commands.

Thus, in this preferred embodiment, a communication system 32 is provided, allowing transfer of command signals, and the receiving means 31 may be any suitable means adapted for cooperation with such communication system 32. For instance, the communication system 32 may be a telephone system, and the receiving means 31 may comprise a telephone receiver. Or, the communication system 32 may be an RF telecommunication system, and the receiving means 31 may comprise a radio receiver.

In the most preferred embodiment, it is possible to send individual commands to individual controllers. To this end, the communication system 32 may have individual communication channels to each of the controllers. Preferably, however, the communication system 32 has one or more communication channels common to two or more of the controllers, and a communication method is used where each controller has a specific code (address), and commands for a target controller are provided with the corresponding identifying code. In a very suitable embodiment, the communication system comprises a communication network such as the Internet, an intranet, or the like, and each controller has an (Internet) address.

The communication system 32 may be wired or wireless; in case of a wired communication system, the system may comprise separate, dedicated communication lines, but the commands may also be transferred over the power lines. Especially in situations where different traffic information systems 1A, 1B, 1C are located in relatively close proximity to each other, such as is the case when the systems 1 are incorporated in street lighting armatures, the communication system 32 may advantageously be an optical communication system, in which case the receiving means 31 comprise optical transceivers linking the controller 30 to one or more neighbouring controllers of neighbouring systems 1, so that each system 1 is associated with a node in the network.

Since communication systems of the types mentioned above are known per se, it is not necessary here to explain their design and operation in more detail.

In the case of information patterns 4 being projected on a projection area 2 of the road surface 3 using a light beam 11 such as a laser beam, the light will reflect from the road surface and will be scattered in virtually all directions, so that only a relatively small portion of the light power reaches the driver of an approaching vehicle V. Since the information pattern is intended for said driver only, light scattered into other directions can be considered a loss.

A further objective of the present invention is to reduce such losses. In one particular embodiment, the present invention advantageously uses the fact that surfaces, including road surfaces, tend to reflect light substantially mirror-like (forward reflection, angle of reflection equals angle of incidence). Based on this understanding, the projection area 2 is preferably located upstream (in terms of traffic flow) of the corresponding system 1, as schematically illustrated in FIG. 5. In a case where traffic may be expected from two (or more) directions (see for instance FIGS. 4A and 4B), a system 1 may have two (or more) different projection areas, each located upstream with respect to the corresponding traffic flow, and the controller 30 controls the deflection system 20 such that the pattern (47) is projected on the correct projection area.

In another particular embodiment, the upper surface of the projection area 2 has a structure which comprises a plurality of projections 60 having at least one sloping reflective surface 61, directed towards possible approaching traffic, as schematically illustrated in FIG. 6. In a case where traffic may be expected from two (or more) directions (see for instance FIGS. 4A and 4B), the projections 60 may have two (or more) different sloping reflective surfaces, each directed towards to the corresponding traffic flow.

In another advantageous embodiment, the upper surface of the projection area 2 may comprise one or more luminescent substances, for instance phosphor-containing substances, which will emit light when irradiated. In such embodiment, it is advantageous if the luminescent substances have a memory-property, i.e. they glow not only for as long as they are irradiated but they glow somewhat longer, even after the laser beam is gone.

In a further elaboration of the present invention, the upper surface of the projection area 2 is provided with a matrix of active pixels, which actively emit light in response to irradiation by a laser beam, similar to the screen of a television.

The pixels may have different colours, so that the controller 30 is capable, by suitably directing and switching the laser beam 11, to project images in colour. This is specifically useful if it is intended to indicate that a road is closed (red sign) or open (green sign).

The pixels may be luminescent pixels. However, the pixels may also contain light sources, for instance LEDs, each provided with a detector for detecting the laser beam, and a controller adapted to switch the LED ON and OFF on the basis of a detection output signal of said detector. The matrix is further connected to a power source. The controller may be designed to hold the ON state of the LED for some time after the laser beam has gone, to implement a memory effect. This hold time may be as long as a frame time.

The hold time may also be indefinite, in which case the laser beam has a switch function. In response to a first irradiation by the laser beam, the controller switches the LED to its ON state; in response to a second irradiation by the laser beam, the controller switches the LED to its OFF state. As long as the matrix is intended to generate the same pattern, the laser beam can remain inactive. Only if it is intended to change the pattern, the laser beam needs to be employed for switching ON some of the LEDs and for switching OFF some others of the LEDs.

In this respect, the laser light may be modulated with some code, one code having the meaning of a SWITCH ON command, another code having the meaning of a SWITCH OFF command. The controller, on receiving an output signal from said detector, will recognize the code and will decide to switch the corresponding LED ON or OFF.

In another embodiment, each pixel comprises a window and a reflection element comprising a reflective surface and a non-reflective surface (i.e. a surface have less reflectivity than the reflective surface). In an ON state of the pixel, the reflective surface will be visible in the window. In an OFF state of the pixel, the nonreflective surface will be visible in the window. The reflective surface and the non-reflective surface may be two adjoining surfaces of one element, switching being done by shifting the element so that either its reflective surface or its non-reflective surface is aligned with the window. The reflective surface and the non-reflective surface may be two opposite surfaces of one element, switching being done by rotating the element so that either its reflective surface or its non-reflective surface is aligned with the window. The reflective surface and the non-reflective surface may be arranged on two different elements arranged to overlap each other, at least the upper element being displaceable, switching being done by displacing the upper element so that either surface or of the lower element or the surface of the upper element is visible.

An advantage of such embodiment is that power is only needed for changing the state of a pixel, not for holding the state of a pixel.

Especially in cases where the pattern 4 is projected stationary, it may happen that an object, for instance a vehicle, is located over a portion of the projection area 2, so that the light beam 11 can not reach the projection area 2 to project the pattern. In that case, there is not much point in continuing with projecting the light beam to this portion of the projection area 2. Further, the light beam may be scattered unpredictably by such object, which may be annoying to people. Therefore, the controller 30 preferably is associated with a detector (not shown for sake of simplicity) for detecting reflected light. From the time between emission and reflection, the controller can calculate the distance of the reflective surface. If this time is reduced, and/or if the amount of detected reflection light is reduced, indicating that an interfering object is blocking and/or scattering the light beam 11, the controller may be designed to reduce the light power for the corresponding portion of the pattern. For those portions of the pattern where the reflection signal indicates that there is no (or no longer any) blockage, the controller may be designed to increase the light power for the corresponding portions of the pattern to normal level.

It should be clear to a person skilled in the art that the present invention is not limited to the exemplary embodiments discussed above, but that several variations and modifications are possible within the protective scope of the invention as defined in the appending claims.

For instance, a pattern 4 may comprise several signs with mutually different meanings. Further, a controller 30 may be designed to have the laser project multiple patterns simultaneously, but it is also possible that different patterns are projected in subsequent “frames”.

In the above, an example is described where the pattern moves along with a vehicle, projected just in front of the vehicle. In case two vehicles are approaching, one relatively close after the other, the system may be designed to project two patterns, one in front of the first vehicle and one in front of the second car, in intermittent time frames.

Further, the controller 30 may be equipped to communicate with the vehicles. For instance, the vehicles may have tire pressure sensors. If the pressure in any tire is too low, the vehicle may send a message to the controllers 30, either directly or through the network 32, and each controller will project a suitable warning message text, to be read only by the driver of the vehicle in question.

Further, it is noted that, in order to be able to detect traffic situations like jams, obstacles (49), etc, a traffic management system may comprise a system of cameras, such as known per se, sending traffic images to a central location, where a supervisor may assess the information of those images and may generate adequate commands for the pattern controllers 30.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Traffic information system (1), comprising:
a light source (10), designed for generating a relative narrow, intense light beam (11);
housing means (100) adapted for being mounted adjacent or above a road surface (3), accommodating the light source (10), having a beam exit window (101) for allowing the light beam (11) to exit the housing;
a controllable beam deflection system (20), capable of changing a direction of the light beam (11) towards a projection area (2) on the road surface (3) in order to form a relatively small light spot (12) on the projection area (2);
a control circuit (30) for controlling the controllable beam deflection system (20) such as to effectively make the light spot (12) draw a predefined pattern (4) on the projection area (2).

2. Traffic information system according to claim 1, wherein the light source (10) comprises a laser device.

3. Traffic information system according to claim 1, wherein the control circuit (30) is adapted to effectively make the light spot (12) follow the predefined pattern (4).

4. Traffic information system according to claim 1, wherein the control circuit (30) is adapted to effectively make the light spot (12) scan the entire projection area (2).

5. Traffic information system according to claim 1, wherein the light source (10) is a controllable light source, controlled by the control circuit (30), and wherein the control circuit (30) is adapted to suitably switch the light source (10) ON/OFF in order to draw said predefined pattern.

6. Traffic information system according to claim 1, wherein the control circuit (30) is adapted to suitably vary the scan speed of the light spot (12), such that the scan speed is relatively high for dark pattern portions and relatively low for bright pattern portions.

7. Traffic information system according to claim 1, wherein the projection area (2) at least partly is located upstream of the beam exit window (101).

8. Traffic information system according to claim 1, wherein the control circuit (30) is adapted to move the pattern (4) over the road surface (3), in a direction parallel to the direction of expected road traffic.

9. Traffic information system according to claim 8, the system further comprising means for detecting position and/or speed of vehicles, wherein the control circuit (30) is designed to move the pattern (4) with substantially the same speed as an approaching vehicle while positioning the pattern (4) in front of this vehicle.

10. Traffic information system according to claim 1, wherein the projection area (2) comprises projections (60) with at least one sloping reflective surface (61).

11. Traffic information system according to claim 1, wherein the upper surface of the projection area (2) comprises one or more luminescent substances.

12. Traffic information system according to claim 11, wherein the upper surface of the projection area (2) is provided with a matrix of pixels.

13. Traffic information system according to claim 12, wherein the matrix comprises active pixels, adapted to actively emit light in response to irradiation by a laser beam.

14. Traffic information system according to claim 12, wherein the matrix comprises luminescent pixels.

15. Traffic information system according to claim 12, wherein the matrix comprises pixels with mutually differing colours.

16. Traffic information system according to claim 12, wherein a pixel contains at least one electrically powered light source, for instance a LED.

17. Traffic information system according to claim 12, wherein a pixel is provided with a detector for detecting the laser beam, and a pixel controller adapted to switch the LED ON and OFF on the basis of a detection output signal of said detector.

18. Traffic information system according to claim 17, wherein the pixel controller is designed to hold the ON state of the LED for a predetermined time after having received an irradiation by the laser beam, and to switch the LED to its OFF state after said predetermined time has passed.

19. Traffic information system according to claim 17, wherein the pixel controller is designed to switch the LED to its ON state in response to receiving a first irradiation by the laser beam; to hold the ON state of the LED until receiving a next irradiation by the laser beam; to switch the LED to its OFF state in response to receiving the next irradiation by the laser beam; and to hold the OFF state of the LED until receiving a further next irradiation by the laser beam.

20. Traffic information system according to claim 17, wherein the laser light is modulated with a first code or a second code; wherein the pixel controller is designed to switch the LED to its ON state in response to receiving a laser beam being modulated with the first code; wherein the pixel controller is designed to switch the LED to its OFF state in response to receiving a laser beam being modulated with the second code.

21. Traffic information system according to claim 17, wherein a pixel comprises a controllable reflection element comprising a reflective surface and a non-reflective surface, and wherein the pixel controller is designed to control said reflection element such that its reflective surface is visible during an ON state and such that its non-reflective surface is visible during an OFF state.

22. Traffic information system according to claim 12, wherein the control circuit (30) is designed to irradiate pixels individually.

23. Traffic information system according to claim 1, wherein the controller (30) is adapted to draw a first predetermined pattern during a first time period of the day, and to draw a second, different predetermined pattern during a second time period of the day.

24. Traffic information system according to claim 1, wherein the controller (30) is provided with receiving means (31) for receiving command signals.

25. Traffic information system according to claim 24, wherein the controller (30) is capable of communicating over a communication network (32).

26. Traffic information system according to claim 24, wherein the housing (100) is provided with at least one transceiver, preferably an optical transceiver, such as to constitute a node in a communication network (32).

27. Traffic information system according to claim 24, wherein the controller (30) is adapted to draw lane marking lines (44, 45, 46), and to change the shape and/or location of the lane marking lines (44, 45, 46) in response to receiving a corresponding command.

28. Traffic information system according to claim 1, wherein the controller (30) is adapted to draw traffic direction arrows (47), and to change the direction of the traffic direction arrows (47) in response to receiving a corresponding command, or at a predefined moment in time.

29. Traffic information system according to claim 1, wherein the controller (30) is provided with a detector for detecting reflected light; wherein the controller (30) is adapted to determine whether reflected light is reflected by road surface or by an interfering object on the road; and wherein the controller (30) is adapted to reduce the light power at least for those portions of the pattern where the reflection signal indicates reflection by an interfering object.
